(19) United States
(12) Patent Application Publication
(10) Pub. No.: US 2017/0018990 A1
(43) Pub. Date: Jan. 19, 2017

(54) DAMPING UNIT

(71) Applicants: ROBERT BOSCH GMBH, Stuttgart-Feuerbach (DE); ITB PRECISIETECHNIEK, Boxtel (NL)

(72) Inventors: Wolfgang WINKLER, Schutterwald (DE); Hans VEREIJKEN, Someren-Eind (NL)

(21) Appl. No.: 15/119,159

(22) PCT Filed: Dec. 18, 2014
(86) PCT No.: PCT/EP2014/078535

§ 371 Date: Aug. 16, 2016

(30) Foreign Application Priority Data
Feb. 19, 2014 (DE) 10 2014 102 134.7

(51) Int. Cl. H02K 5/167; F16C 27/08; F16C 27/02; H02K 5/16; H02K 5/24

(52) U.S. Cl. CPC H02K 5/1672; H02K 5/161; H02K 5/24; F16C 27/02; F16C 27/08; F16C 2220/04; F16C 2380/26

(57) ABSTRACT

The invention is based on a damping unit with at least one bearing element (12) which is provided for damping at least one longitudinal armature oscillation of an electromotor in at least one operating state and which comprises at least one hollow space (14) for damping the at least one longitudinal armature oscillation of the electromotor in at least one operating state and which comprises at least one first injection-molded element (16) and at least one second injection-molded element (18).

It is proposed that the at least one hollow space (14) is arranged at least substantially in the at least one first injection-molded element (16) or in the at least one second injection-molded element (18).

### STATE OF THE ART

A damping unit according to the preamble of claim 1 has already been proposed.

### DISCLOSURE OF THE INVENTION

The invention relates to a damping unit with at least one bearing element which is provided for damping at least one longitudinal armature oscillation of an electromotor in at least one operating state and which comprises at least one hollow space for damping the at least one longitudinal armature oscillation of the electromotor in at least one operating state and which comprises at least one first injection-molded element and at least one second injection-molded element.

It is proposed that the at least one hollow space is arranged at least substantially in the at least one first injection-molded element or in the at least one second injection-molded element. The at least one bearing element is preferably embodied at least partially as a thrust washer. However, other implementations of the at least one bearing element are also conceivable which are deemed expedient by a person having ordinary skill in the art. By “damping” is in particular to be understood, in this context, that the at least one bearing element and/or the at least one hollow space are/is provided for converting vibrations and/or oscillations implemented as a kinetic energy into thermal energy, and thus in particular for reducing respectively damping in an operating state an oscillation transfer between the electromotor and at least one housing of a heating fan and/or air-conditioning fan comprising the electromotor. The at least one bearing element preferably comprises, in particular in a region adjacent to the at least one hollow space, an elastic modulus that is smaller than 500 N/mm², preferentially smaller than 100 N/mm²and particularly preferably smaller than 50 N/mm². The at least one bearing element is, in particular in a region adjacent to the at least one hollow space, elastically compressible in particular by more than 0.1 mm, preferably by more than 0.5 mm and especially preferentially by more than 1 mm.

By a “longitudinal armature oscillation” is in particular to be understood, in this context, a movement, in particular an oscillating movement, of an armature element of an electromotor, which has at least one component that is arranged in parallel to a rotary axis of the electromotor. The longitudinal armature oscillation is preferably generated in an operating state of the electromotor. The armature element of the electromotor is preferably supported rotatably and is in an operating state of the electromotor implemented in such a way that it is rotatingly drivable, in particular with respect to a stator unit. “Provided” is to mean, in particular, specifically implemented, configured and/or equipped. By an object being provided for a certain function is in particular to be understood that the object fulfills and/or executes said certain function in at least one application state and/or operating state.

A “hollow space” is in particular to be understood, in this context, as a spatial, in particular non-material region of the at least one bearing element, which is at least approximately completely enclosed by the at least one bearing element and is embodied differing from a basic porosity of a material or material mixture of the at least one bearing element. The at least one hollow space has a main extension that is in particular at least twice, preferably at least three times, preferentially no less than five times and particularly preferably at least ten times as great as an average pore size of the basic porosity of a material or material mixture of the at least one bearing element. The main extension of the at least one hollow space amounts to in particular at least 1 mm, preferably no less than 5 mm, preferentially at least 1 cm and particularly preferably at least 5 cm.

By an “injection-molded element” is in particular to be understood, in this context, an element which is produced and/or formed at least partly, preferably at least approximately entirely in an injection-molding procedure. The injection-molded element is preferably embodied at least partly, preferably at least approximately entirely of at least one plastic material.

By “arranged at least substantially in an element” is in particular to be understood, in this context, that the at least one hollow space is enclosed by the material or material mixture of the at least one bearing element in particular by at least 50%, preferably by at least 70%, preferentially by at least 90% and particularly preferably by at least 98%, in particular when viewed in at least two spatial directions, preferably in three spatial directions.

By the implementation of the damping unit according to the invention a longitudinal armature oscillation of the armature element of the electromotor may be damped in an operating state and running noises of the electromotor may be reduced in an advantageously simple manner.

It is further proposed that the at least one hollow space is arranged at least partly along a circumferential direction of the bearing element. “Along a circumferential direction” is in particular to mean, in this context, that a main extension of the at least one hollow space is arranged at least mainly at least approximately in parallel to the circumferential direction of the at least one bearing element. This allows achieving an advantageously compact implementation of the at least one bearing element.

Furthermore it is proposed that the at least one hollow space is embodied at least partly ring-shaped. “Ring-shaped” is in particular to mean, in this context, that the at least one hollow space has, in a plane extending in parallel to the main extension of the at least one hollow space, a cross section having an annulus-shaped contour. In this way a structurally simple and preferentially cost-efficient implementation of the at least one bearing element is achievable.

It is also proposed that the damping unit comprises at least two bearing elements, which are provided for damping at least an longitudinal armature oscillation of an electromotor in at least one operating state. This allows achieving a preferentially effective damping of the longitudinal armature oscillation of the electromotor in at least one operating state in an advantageously simple fashion.

Moreover it is proposed that the at least one first injection-molded element and the at least one second injection-molded element are at least partly fixedly connected to each other. By “fixedly connected” is in particular to be understood, in this context, that the at least one first injection-molded element and the at least one second injection-molded element are connected to each other in particular captively, preferably in such a way that they are non-releasable or are only separable by destruction. The at least one first injection-molded element and the at least one second injection-molded element may be connected to each other at least partly in a form-fit and/or force-fit manner, a holding force between the at least one first injection-molded element and the at least one second injection-molded element being transferred preferably by the structural components geometrically engaging one into the other and/or by a friction force between the structural components. In a particularly preferred exemplary embodiment the at least one first injection-molded element and the at least one second injection-molded element are connected to each other at least partly by substance-to-substance bond.

“Connected by substance-to-substance bond” is in particular to mean that the at least one first injection-molded element and the at least one second injection-molded element are held together by atomic or molecular forces as, for example, with soldering, welding, adhesive bonding and/or vulcanization. This allows achieving an advantageously robust and preferably reliable implementation of the at least one bearing element.

Furthermore it is proposed that the at least one first injection-molded element and the at least one second injection-molded element are embodied at least partly in a one-part implementation. A “one-part implementation” is in particular to mean, in this context, at least connected by substance-to-substance bond, e.g. by a welding process, an adhesive-bonding process, an injection-molding procedure and/or by another process deemed expedient by the person skilled in the art, and/or advantageously formed in one piece, e.g. by a production from one cast and/or by a production in a one-component or multi-component injection-molding procedure and advantageously from a single blank. Preferentially the at least one first injection-molded element and the at least one second injection-molded element are produced at least partly in an injection-molding procedure, in particular a multi-step injection-molding procedure. In this way an advantageously simple implementation of the at least one bearing element is achievable.

It is also proposed that the at least one bearing element comprises at least one ultrasonic-machined contact zone between the at least one first injection-molded element and the at least one second injection-molded element. A “contact zone” is in particular to be understood, in this context, as a zone in which the at least one first injection-molded element and the at least one second injection-molded element directly contact each other and in which the at least one first injection-molded element and the at least one second injection-molded element are preferably connected. “Ultrasonic-machined” is in particular to mean, in this context, that the contact zone has been machined at least partly by an ultrasonic procedure, in particular by means of an ultrasonic-welding procedure, in particular to increase an adhesion between the at least one at least one first injection-molded element and the at least one second injection-molded element in the contact zone. As an alternative or additionally, however, other procedures deemed expedient by a person skilled in the art are also conceivable for increasing the adhesion between the at least one first injection-molded element and the at least one second injection-molded element in the contact zone. In this way a preferentially secure and reliable connection between the at least one first injection-molded element and the at least one second injection-molded element is achievable in an advantageously simple fashion.

Further it is proposed that the at least one hollow space is embodied at least substantially airtight at least in an assembled state. By “at least substantially airtight” is in particular to be understood, in this context, that a fluid exchange, in particular an air exchange, between the at least one hollow space and an environment of the at least one bearing element amounts to in particular less than 0.1 l/h, preferentially less than 0.05 l/h, preferably less than 0.01 l/h and particularly preferably less than 0.001 l/h. This allows achieving a fluid cushion, in particular an air cushion, within the at least one hollow space and thus preferentially good damping characteristics of the at least one bearing element.

It is moreover proposed that the at least one first injection-molded element and the at least one second injection-molded element are embodied at least partly of an identical material. This allows achieving a structurally simple and preferentially cost-efficient implementation of the at least one bearing element.

Further it is proposed that the at least one bearing element comprises at least one interlocking element, which is provided at least partly for a form-fit coupling between the at least one first injection-molded element and the at least one second injection-molded element. By a “form-fit coupling” is in particular to be understood, in this context, that adjacent surfaces of the structural components that are connected to each other in a form-fit fashion exert a holding force onto each other which acts in a normal direction of the surfaces. In particular the at least one first injection-molded element and the at least one second injection-molded element are engaged with each other geometrically. In this way a preferentially secure and reliable connection between the at least one first injection-molded element and the at least one second injection-molded element is achievable in an advantageously simple fashion.

It is furthermore proposed that the at least one interlocking element is embodied at least partly in a one-part implementation with the at least one first injection-molded element or with the at least one second injection-molded element. By a “one-part implementation” is in particular to be understood, in this context, at least connected by substance-to-substance bond, e.g. by means of a welding process, an adhesive-bonding process, an injection-molding procedure and/or by another process deemed expedient by the person skilled in the art, and/or advantageously formed in one piece, e.g. by a production from one cast and/or by a production in a one-component or multi-component injection molding procedure, and advantageously from a single blank. Preferentially the at least one interlocking element and the at least one first injection-molded element or the at least one second injection-molded element are produced at least partly in an injection-molding procedure. In this way an advantageously simple implementation of the at least one bearing element is achievable.

Moreover an electromotor is proposed, with at least one armature shaft, with at least one armature element, with at least one commutator, with at least one first support element and at least one second support element and with the damping unit, which is arranged on the armature shaft at least partly between the at least one first support element and the at least one armature element and/or at least partly between the at least one commutator and the at least one second support element. The at least one first support element and/or the at least one second support element are/is provided for a support, in particular rotatable support, of the at least one armature shaft and in particular of the at least one armature element. The electromotor is provided for driving in an operating state a heating fan and/or air-conditioning fan. However, other applications of the electromotor deemed expedient by a person skilled in the art, e.g. in a handheld machine tool, are also conceivable. This allows achieving an advantageously quiet and preferably low-noise implementation of the electromotor.

The invention is furthermore based on a method for producing the damping unit.

It is proposed that the method comprises at least one method step, in which at least one bearing element of the damping unit is at least partly formed in an at least two-step injection molding procedure. By a “two-step injection molding procedure” is to be understood, in this context, in particular an injection molding procedure in which in a first step a first part of the at least one bearing element and in at least one further step at least one further part of the at least one bearing element is formed, in particular injected. In this way an advantageously flexibly implemented bearing element of the damping unit is achievable.

Furthermore it is proposed that the method comprises at least one further method step, in which the at least one bearing element is treated at least partly by an ultrasonic-welding procedure. An “ultrasonic-welding procedure” is to be understood, in this context, in particular as a method for increasing an adhesion between the at least one first injection-molded element and the at least one second injection-molded element, in particular in the contact zone, by means of sound having a frequency at a level above the frequency range of human hearing and preferably between 16 kHz and 1 GHz. In this way a preferentially secure and reliable connection between the at least one first injection-molded element and the at least one second injection-molded element is achievable in an advantageously simple manner.

It is moreover proposed that the method comprises at least one further method step, in which at least one hollow space, which is arranged in at least one first injection-molded element or in at least one second injection-molded element of the at least one bearing element, is being at least substantially closed. By “at least substantially closed” is in particular to be understood, in this context, that the at least one hollow space is enclosed by the material or material mixture of the at least one bearing element by at least 50%, preferably by at least 70%, preferentially by at least 90% and particularly preferably by at least 98%, in particular when viewed in at least two spatial directions, preferably in three spatial directions. In this way a fluid cushion, in particular an air cushion, within the at least one hollow space, and thus preferentially good damping characteristics of the at least one bearing element are achievable.

The damping unit is herein not to be restricted to the application form and implementation form described above. In particular, the damping unit may, for fulfilling a functionality herein described, a number of respective elements, structural components and units that differs from a number mentioned herein.

### DRAWING

Further advantages may be gathered from the following description of the drawing. In the drawing two exemplary embodiments of the invention are shown. The drawing, the description and the claims contain a plurality of features in combination. The person skilled in the art will purposefully also consider the features separately and will find further expedient combinations.

It is shown in:

FIG. 1 a rotor unit of an electromotor with a damping unit in a schematic lateral view,

FIG. 2 a section of a bearing element of the damping unit in a sectional view,

FIG. 3a the bearing element of the damping unit in a perspective view from above,

FIG. 3b the bearing element of the damping unit in a perspective view from below,

FIG. 4 the bearing element of the damping unit in a sectional view,

FIG. 5a a first injection-molded element of the bearing element of the damping unit in a sectional view,

FIG. 5b a second injection-molded element of the bearing element of the damping unit in a sectional view,

FIG. 6 a section of the bearing element of the damping unit with the first injection-molded element and the second injection-molded element in a coupled state in a sectional perspective view,

FIG. 7 a section of the bearing element of the damping unit with an ultrasonic-welded zone between the first injection-molded element and the second injection-molded element in a sectional view,

FIG. 8 a bearing element of an alternatively implemented damping unit with several interlocking elements in a perspective view,

FIG. 9 the bearing element of the alternatively implemented damping unit in a sectional perspective view,

FIG. 10 a section of the bearing element of the alternatively implemented damping unit in a sectional view, and

FIG. 11 a schematic flow diagram of a method for producing the damping unit.

### DESCRIPTION OF THE EXEMPLARY EMBODIMENTS

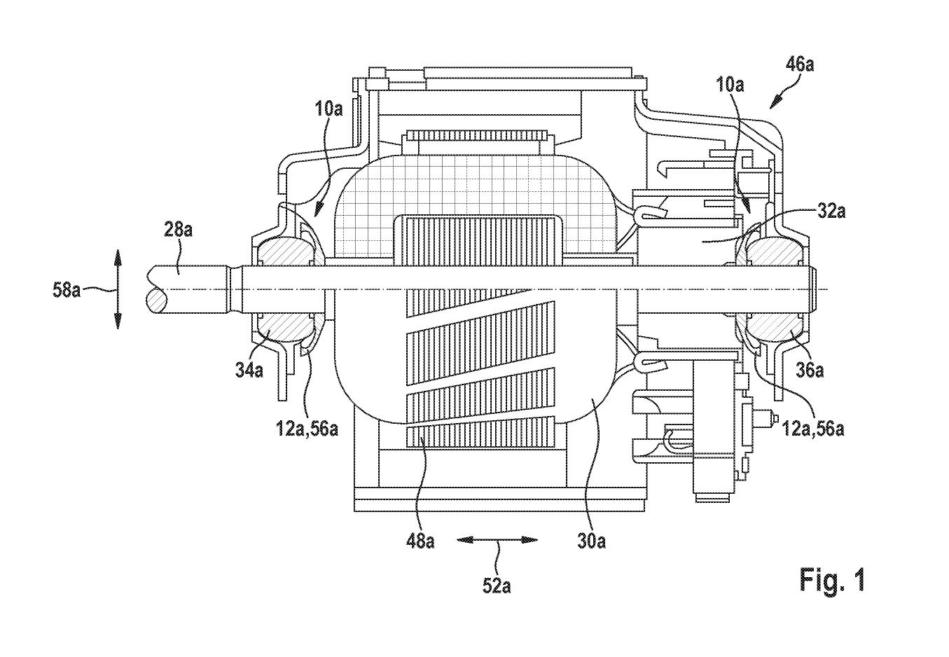

FIG. 1 shows a rotor unit 46a of an electric drive device embodied by an electromotor. The electromotor is provided for driving an electric heating fan and/or air-conditioning fan. The electromotor is implemented as a DC motor. It is however also conceivable that the electromotor is implemented as a BLDC motor or in another way that is deemed expedient by a person having ordinary skill in the art. The electromotor comprises an armature element 30a, a commutator 32a, a first support element 34a, a second support element 36a and a damping unit 10a. The rotor unit 46a of the electromotor comprises the armature element 30a. The armature element 30a is implemented of iron. The armature element 30a is implemented of iron sheets that are stacked on each other. The armature element 30a comprises grooves (not shown in detail), in which runs at least one turn 48a. The armature element 30a comprises a plurality of turns 48a. The turns 48a are connected to the schematically depicted commutator 32a. The turns 48a extend across a winding head of the armature element 30a. The armature element 30a comprises two winding heads, which are arranged opposite each other in a main extension direction 52a of the armature element 30a. The main extension direction 52a of the armature element 30a extends in parallel to the armature shaft 28a of the rotor unit 46a.

In a region of the winding head the turns 48a are arranged crossing each other. The turns 48a are provided to be flown through by an electric current in an operating state, as a result of which a magnetic field is induced. The magnetic field induced acts in an operating state together with a magnetic field of a (not shown) stator unit of the electromotor. The rotor unit 46a further comprises an output gearing (not shown) for transferring an output movement of the rotor unit 46a of the electromotor onto a drive spindle of the heating fan and/or air-conditioning fan.

The electromotor moreover comprises the first support element 34a and the second support element 36a, which support the rotor unit 46a in such a way that it is rotatable about a rotary axis of the armature shaft 28a. The first support element 34a and the second support element 36a are arranged, viewed in a main extension direction 52a of the rotor unit 46a of the electromotor, on opposite sides of the armature element 30a. The first support element 34a and the second support element 36a encompass the armature element 30a, viewed in a main extension direction 52a of the rotor unit 46a of the electromotor. The first support element 34a and the second support element 36a directly contact the armature shaft 28a. The first support element 34a is arranged, viewed in the main extension direction 52a of the rotor unit 46a of the electromotor, on a side of the rotor unit 46a of the electromotor that faces away from the commutator 32a. The second support element 36a is arranged, viewed in the main extension direction 52a of the rotor unit 46a of the electromotor, on a side of the rotor unit 46a of the electromotor that faces towards the commutator 32a. The first support element 34a and the second support element 36a are embodied as slide bearings. The first support element 34a and the second support element 36a are embodied by cup-and-ball bearings. However, other implementations of the first support element 34a and/or of the second support element 36a are also conceivable which are deemed expedient by a person having ordinary skill in the art. The armature element 30a of the rotor unit 46a is supported rotatably with respect to the first support element 34a and the second support element 36a. The armature element 30a of the rotor unit 46a has, viewed in the main extension direction 52a of the rotor unit 46a of the electromotor, a longitudinal clearance with respect to the first support element 34a and the second support element 36a. The longitudinal clearance has an amount between 0.1 mm and 0.4 mm. In an operating state of the electromotor a longitudinal armature oscillation and thus a high running-noise level of the electromotor may result from the longitudinal clearance of the armature element 30a.

For the purpose of damping the longitudinal armature oscillation of the armature element 30a in an operating state of the electromotor, the damping unit 10a is provided. The damping unit 10a is arranged on the armature shaft 28a at least partly between the at least one first support element 34a and the at least one armature element 30a and/or at least partly between the at least one commutator 32a and the at least one second support element 36a. The damping unit 10a comprises at least one bearing element 12a. The damping unit 10a comprises at least two bearing elements 12a. The damping unit 10a comprises a first bearing element 12a and a second bearing element 12a. The first bearing element 12a and the second bearing element 12a are each embodied as a thrust washer 56a. The bearing elements 12a are embodied disk-shaped. It is however also conceivable that the bearing elements 12a are embodied at least partly shaped like disk segments. Viewed in the main extension direction 52a of the rotor unit 46a of the electromotor, the first bearing element 12a is arranged between the first support element 34a and the armature element 30a. Viewed in the main extension direction 52a of the rotor unit 46a of the electromotor, the second bearing element 12a is arranged between the commutator 32a and the second support element 36a.

In an operating state of the electromotor axial forces transferred from the armature element 30a onto the support elements 34a, 36a by the longitudinal armature oscillation are transferred onto the bearing elements 12a and cushioned via surfaces of the bearing elements 12a which are arranged perpendicularly to the main extension direction 52a. The bearing elements 12a are implemented of a plastic material. However, other implementations of the bearing elements 12a, e.g. in particular of an additional or alternative material, which are deemed expedient by a person skilled in the art, are also conceivable. In the exemplary embodiment shown in FIG. 1 the damping unit 10a is arranged inside a housing of the electromotor. It is however also conceivable that the damping unit is arranged at least partly outside the housing of the electromotor.

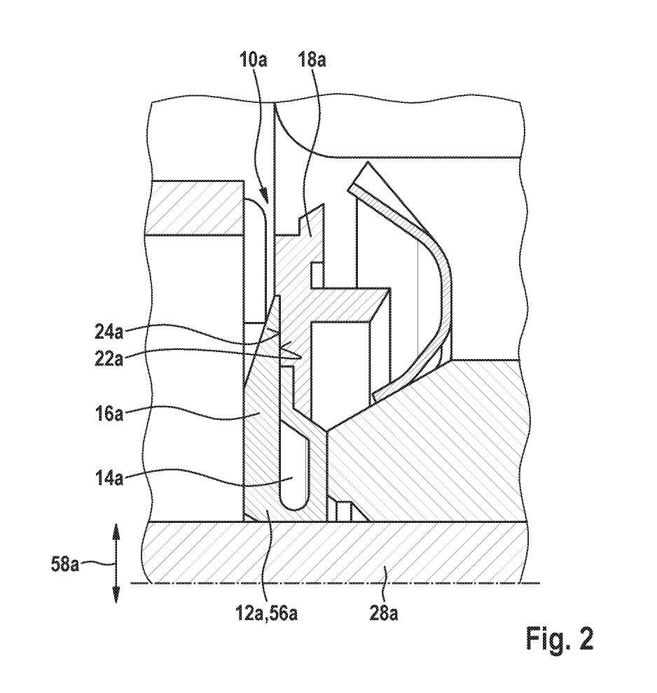

FIG. 2 shows a section of one of the bearing elements 12a in a sectional view. The first bearing element 12a and the second bearing element 12a are embodied at least substantially identical. The first bearing element 12a and the second bearing element 12a are embodied identical. The first bearing element 12a comprises at least one hollow space 14a for damping the at least one longitudinal armature oscillation of the electromotor in at least one operating state. The second bearing element 12a comprises at least one hollow space 14a for damping the at least one longitudinal armature oscillation of the electromotor in at least one operating state. The bearing elements 12a each comprise a hollow space 14a for damping the at least one longitudinal armature oscillation of the electromotor in at least one operating state. The hollow space 14a in an assembled state forms respectively one fluid cushion, which is provided for damping the longitudinal armature oscillation of the electromotor in an operating state. The hollow space 14a in an assembled state forms respectively one air cushion. The hollow space 14a implements a damping region of the respective bearing element 12a.

The hollow space 14a is respectively arranged at least partly along a circumferential direction 20a of the bearing elements 12a. The hollow space 14a is respectively circumferentially arranged along the circumferential direction 20a of the bearing elements 12a. The hollow space 14a is respectively embodied ring-shaped. In a plane arranged perpendicularly to a tangential direction of the bearing element 12a, the hollow space 14a respectively comprises two cross-section areas each of which comprise a triangular region, a rectangular region and a semicircular region. The semicircular region, the rectangular region and the triangular region are arranged subsequently to each other if viewed in a radial direction 58a of the bearing element 12a from the inside to the outside. However, other implementations deemed expedient by a person skilled in the art, of the cross-section areas of the hollow space 14a in a plane that is arranged perpendicularly to a tangential direction of the bearing element 12a, e.g. polygonal, drop-shaped, circular, rectangular, oval or square, are also conceivable. Via the hollow space 14a a damping characteristic of the respective bearing element 12a can be influenced and an elastic zone of the respective bearing element 12a is achievable.

In a region of the hollow space 14a, the first injection-molded element 16a comprises, viewed in a radial direction 58a, a zone that serves in an operating state as a bending beam and is elastically deformable toward the hollow space. Axial forces acting in an operating state, due to the longitudinal armature oscillation, from the first support element or from the second support element onto the bearing element generate the elastic deformation of the first injection-molded element 16a in the region of the hollow space 14a and are thus damped.

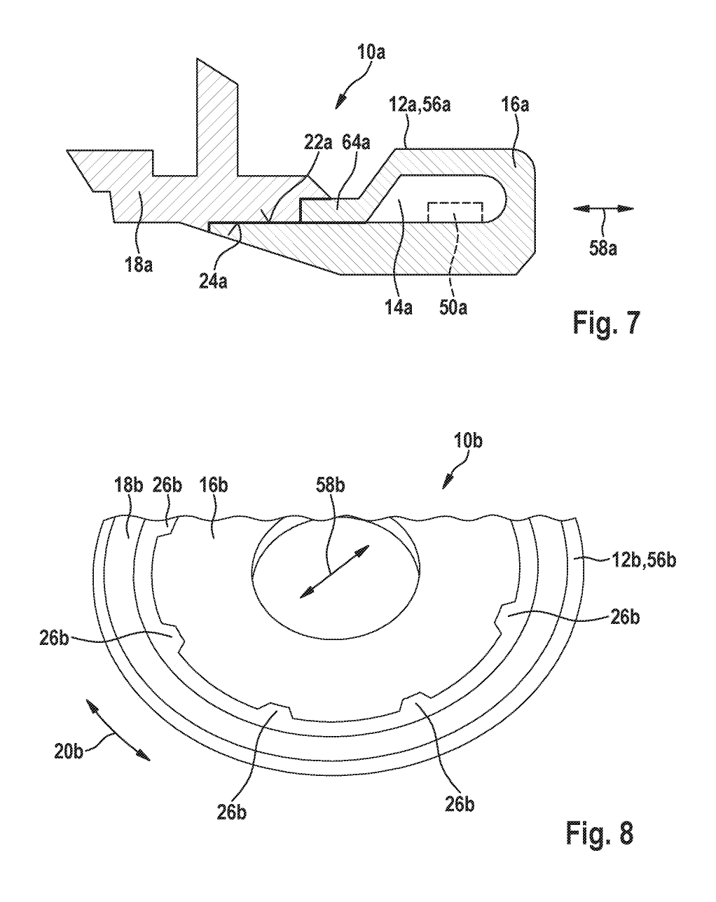

In addition it is conceivable that inside the hollow space 14a a stop element 50a is provided, which is provided for delimiting a deformation of the bearing element 12a in the region of the hollow space 14a in an operating state. The stop element 50a is shown in FIG. 7 by dashed lines. The stop element 50a is made of a plastic material. The stop element 50a may be embodied extending circumferentially along the hollow space 14a. It is however also conceivable that a plurality of stop elements 50a, e.g. three stop elements 50a, are provided which are arranged in such a way that they are regularly distributed along the hollow space 14a, viewed in a circumferential direction 20a. The stop element 50a is fixedly connected to the first injection-molded element 16a of the bearing element 12a. The stop element 50a is embodied in a one-part implementation with the first injection-molded element 16a of the bearing element 12a. It is however also conceivable that the stop element 50a is glued to the first injection-molded element 16a of the bearing element 12a or is connected to the first injection-molded element 16a of the bearing element 12a in another way that is deemed expedient by a person having ordinary skill in the art.

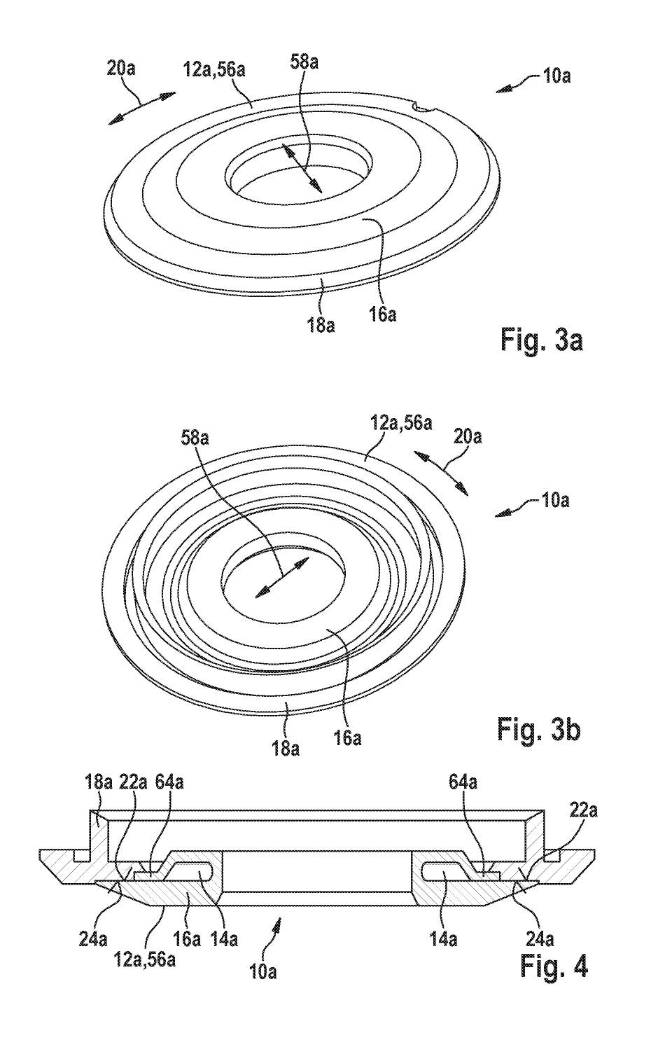

The first bearing element 12a and the second bearing element 12a of the damping unit 10a each comprise a first injection-molded element 16a and a second injection-molded element 18a (FIGS. 3a and 3b). The first injection-molded element 16a and the second injection-molded element 18a are formed successively in a two-step injection-molding procedure. The first injection-molded element 16a and the second injection-molded element 18a are at least partly connected to each other fixedly. The first injection-molded element 16a and the second injection-molded element 18a are respectively connected to each other fixedly. The first injection-molded element 16a and the second injection-molded element 18a are embodied at least partly in a one-part implementation. The first injection-molded element 16a and the second injection-molded element 18a are respectively embodied in a one-part implementation. The first injection-molded element 16a is formed in a first step 60 of the injection-molding procedure. Then the second injection-molded element 18a is formed in a second step 62 of the injection-molding procedure and is injected onto the first injection-molded element 16a. It is however also conceivable that the second injection-molded element 18a is formed separately in the second step 62 of the injection-molding procedure and is then connected to the first injection-molded element 16a.

The first bearing element 12a and the second bearing element 12a each comprise an ultrasonic-machined contact zone 22a, 24a between the first injection-molded element 16a and the second injection-molded element 18a (FIG. 7). The first injection-molded element 16a comprises the contact zone 22a. The second injection-molded element 18a comprises the contact zone 24a. In the ultrasonic-machined contact zone 22a, 24a between the first injection-molded element 16a and the second injection-molded element 18a the first bearing element 12a and the second bearing element 12a each have a high degree of adhesion between the first injection-molded element 16a and the second injection-molded element 18a, thus allowing to prevent releasing of the substance-to-substance bond between the first injection-molded element 16a and the second injection-molded element 18a of the bearing element 12a in an operating state of the damping unit 10a.

The first injection-molded element 16a and the second injection-molded element 18a are embodied at least partly of a same material. The first injection-molded element 16a and the second injection-molded element 18a are respectively embodied completely of the same material. The first injection-molded element 16a and the second injection-molded element 18a are made of a plastic material. However, other materials are also conceivable which are deemed expedient by a person having ordinary skill in the art. The hollow space 14a of the first bearing element 12a and the hollow space 14a of the second bearing element 12a are respectively arranged at least substantially in the first injection-molded element 16a or in the second injection-molded element 18a (FIG. 4). The hollow space 14a of the first bearing element 12a is arranged in the first injection-molded element 16a and is completely enclosed by the first injection-molded element 16a. The hollow space 14a of the second bearing element 12a is arranged in the first injection-molded element 16a and is completely enclosed by the first injection-molded element 16a. It is however also conceivable that the hollow space 14a is arranged in the second injection-molded element 18a and is enclosed by the second injection-molded element 18a. In an assembled state the hollow space 14a of the first bearing element 12a and the hollow space 14a of the second bearing element 12a are each embodied at least substantially airtight. In an assembled state the hollow space 14a of the first bearing element 12a and the hollow space 14a of the second bearing element 12a are each embodied airtight.

FIG. 11 schematically shows a flow diagram of a method for producing the damping unit 10a. In a method step 38, 40 of the method for producing the damping unit 10a, the first bearing element 12a and the second bearing element 12a are at least partly formed in the two-step injection-molding procedure. The first bearing element 12a and the second bearing element 12a are at least approximately completely formed in the method step 38, 40 of the method for producing the damping unit 10a in the two-step injection molding procedure. When the first injection-molded element 16a has been formed in the first step 60 of the injection-molding procedure, which corresponds to the method step 38 of the method, the hollow space 14a introduced into the first injection-molded element 16a is implemented open. The first injection-molded element 16a comprises a lug zone 64a, which is provided for directly contacting a contact zone 22a of the first injection-molded element 16a in an assembled state, thus closing off the hollow space 14a.

In a non-assembled state the lug zone 64a of the first injection-molded element 16a is arranged spaced apart from the contact zone 22a of the first injection-molded element 16a. In a further method step 44 of the method for producing the damping unit 10a, the hollow space 14a, which is arranged in the first injection-molded element 16a or in the second injection-molded element 18a of the first bearing element 12a or the second bearing element 22a, is at least substantially closed. In the further method step 44 of the method for producing the damping unit 10a, the hollow space 14a, which has been introduced into the first injection-molded element 16a, is closed. The hollow space 14a is in the further method step 44 closed by pressing the lug zone 64a onto the contact zone 22a of the first injection-molded element 16a. Then, in the second step 62 of the injection molding procedure, which corresponds to the method step 40 of the method, the second injection-molded element 18a is injected onto the first injection-molded element 16a. As a result of this, the lug zone 64a of the first injection-molded element 16a is fixated with respect to the contact zone 22a of the first injection-molded element 16a in a closed state of the hollow space 14a.

In a further method step 42 of the method for producing the damping unit 10a, the first bearing element 12a and the second bearing element 12a are respectively at least partly treated by an ultrasonic-welding procedure. In the further method step 42 of the method for producing the damping unit 10a, the first bearing element 12a and the second bearing element 12a are respectively treated by an ultrasonic-welding procedure in the contact zone 22a, 24a between the first injection-molded element 16a and the second injection-molded element 18a. However, other procedures for improving an adhesion between the first injection-molded element 16a and the second injection-molded element 18a, which are deemed expedient by a person skilled in the art, are also conceivable. A substance-to-substance bond of the contact zone 22a of the first injection-molded element 16 and the contact zone 24a of the second injection-molded element 18a may be improved in this way.

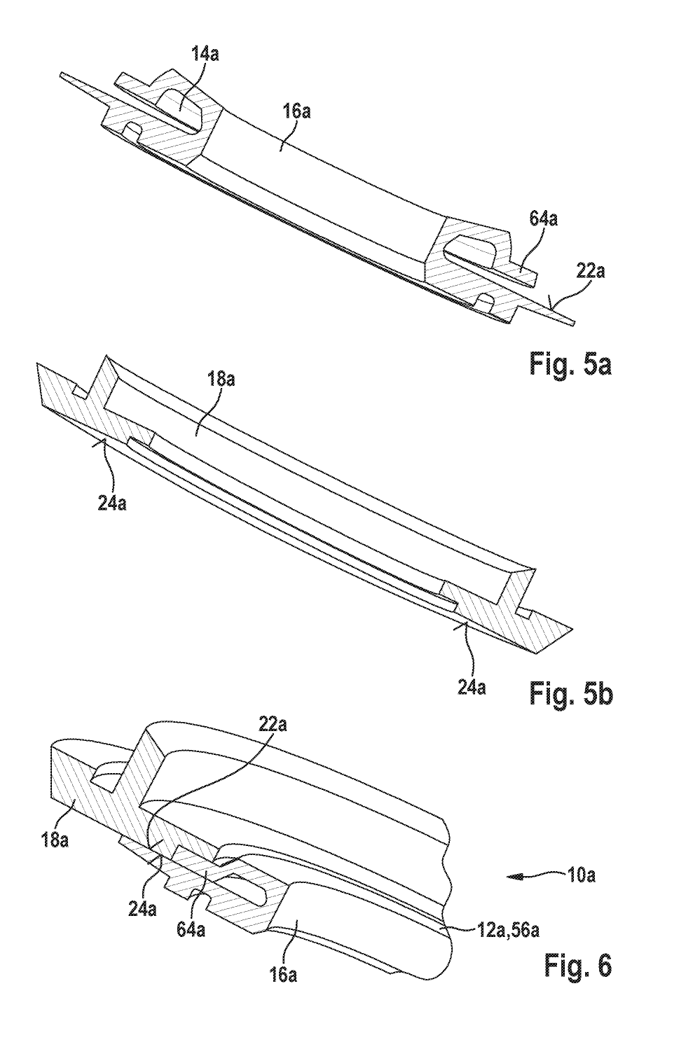

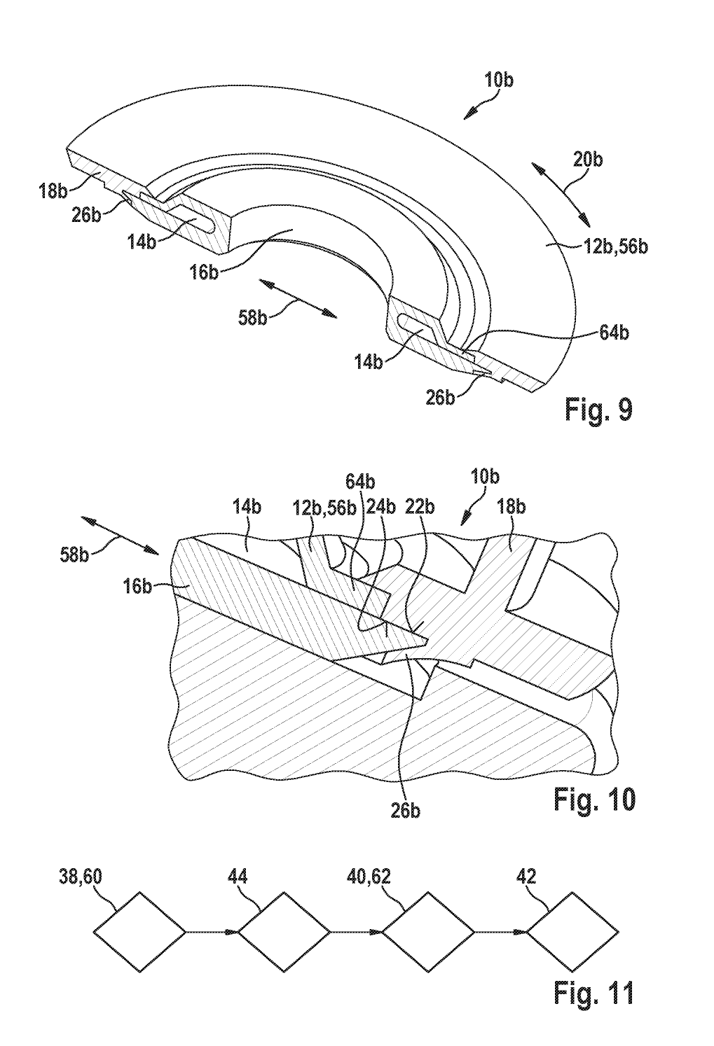

In FIGS. 8 to 10 a further exemplary embodiment of the invention is shown. The following descriptions and the drawings are substantially limited to the differences between the exemplary embodiments, wherein regarding structural components having the same denomination, in particular regarding structural components having the same reference numerals, principally the drawings and/or the description of the other exemplary embodiments, in particular of FIGS. 1 to 7, may also be referred to. For the purpose of distinguishing the exemplary embodiments, the letter a is added to the reference numerals of the exemplary embodiments in FIGS. 1 to 7. In the exemplary embodiments of FIGS. 8 to 10 the letter a has been substituted by the letter b.

FIGS. 8 to 10 show a bearing element 12b of an alternatively implemented damping unit 10b. The bearing element 12b mainly corresponds to the already described bearing element 12a. The alternatively implemented damping unit 10b comprises two bearing elements 12b. The bearing elements 12b are embodied at least substantially identical. The bearing elements 12b are embodied identical. The alternatively implemented damping unit 10b is produced by the method already described. The bearing element 12b comprises a first injection-molded element 16b and a second injection-molded element 18b. The first injection-molded element 16b and the second injection-molded element 18b are successively formed in a two-step injection-molding procedure. The first injection-molded element 16b and the second injection-molded element 18b are at least partly fixedly connected to each other. The first injection-molded element 16b and the second injection-molded element 18b are respectively fixedly connected to each other. The first injection-molded element 16b and the second injection-molded element 18b are embodied at least partly in a one-part implementation. The first injection-molded element 16b and the second injection-molded element 18b are respectively embodied in a one-part implementation. The first injection-molded element 16b is injected onto the second injection-molded element 18b in the injection-molding procedure. The first injection-molded element 16b and the second injection-molded element 18b are connected to each other by substance-to-substance bond.

The bearing element 12b comprises at least one interlocking element 26b, which is provided at least partly for a form-fit coupling between the at least one first injection-molded element 16b and the at least one second injection-molded element 18b. The bearing element 12b comprises at least two interlocking elements 26b. The bearing element 12b comprises a plurality of interlocking elements 26b, which are provided for an additionally form-fit coupling between the first injection-molded element 16b and the second injection-molded element 18b. The interlocking elements 26b are arranged in such a way that they are regularly distributed in a circumferential direction 20b of the bearing element 12b. The bearing element 12b comprises eight interlocking elements 26b, which are regularly distributed in the circumferential direction 20b. At least one of the interlocking elements 26b is embodied at least partly in a one-part implementation with the first injection-molded element 16b or with the second injection-molded element 18b. The interlocking elements 26b are embodied in a one-part implementation with the second injection-molded element 18b. The interlocking elements 26b each comprise a trapezoid-shaped contour extending in a radial direction 58b inwards from an edge of the second injection-molded element 18b, which is an inner edge when viewed in a radial direction 58b of the bearing element 12b. However, other implementations of the interlocking elements, which are deemed expedient by a person skilled in the art, are also conceivable, e.g. in particular with a semi-circular, triangular, ellipse-shaped and/or rectangular contour. In an assembled state the interlocking elements 26b of the second injection-molded element 18b are injection-molded onto the first injection-molded element 16b in a plane that is arranged in parallel to a circumferential direction 20b of the bearing element 12b, and they fixate the first injection-molded element 16b by substance-to-substance bond. In the assembled state the interlocking elements 26b of the second injection-molded element 18b engage over the first injection-molded element 16b in a plane that is arranged in parallel to a circumferential direction 20b of the bearing element 12b, fixating the first injection-molded element 16b in a form-fit fashion.

1. A damping unit with at least one bearing element which is provided for damping at least one longitudinal armature oscillation of an electromotor in at least one operating state and which comprises at least one hollow space for damping the at least one longitudinal armature oscillation of the electromotor in at least one operating state and which comprises at least one first injection-molded element and at least one second injection-molded element wherein the at least one hollow space is arranged at least substantially in the at least one first injection-molded element or in the at least one second injection-molded element.

2. The damping unit according to claim 1, wherein the at least one hollow space is arranged at least partly along a circumferential direction of the bearing element.

3. The damping unit according to claim 1, wherein the at least one hollow space is embodied at least partly ring-shaped.

4. The damping unit according to claim 1, further comprising at least two bearing elements, which are provided for damping at least the longitudinal armature oscillation of the electromotor in at least one operating state.

5. The damping unit according to claim 1, wherein the at least one first injection-molded element and the at least one second injection-molded element are at least partly fixedly connected to each other.

6. The damping unit according to claim 1, wherein the at least one first injection-molded element and the at least one second injection-molded element are embodied at least partly in a one-part implementation.

7. The damping unit according to claim 1, wherein the at least one bearing element comprises at least one ultrasonic-machined contact zone between the at least one first injection-molded element and the at least one second injection-molded element.

8. The damping unit according to claim 1, wherein the at least one hollow space is embodied at least substantially airtight at least in an assembled state.

9. The damping unit according to claim 1, wherein the at least one first injection-molded element and the at least one second injection-molded element are embodied at least partly of an identical material.

10. The damping unit according to claim 1, wherein the at least one bearing element comprises at least one interlocking element, which is at least partly provided for a form-fit coupling between the at least one first injection-molded element and the at least one second injection-molded element.

11. The damping unit according to claim 10, wherein the at least one interlocking element is embodied at least partly in a one-part implementation with the at least one first injection-molded element or the at least one second injection-molded element.

12. An electromotor with at least one armature shaft, with at least one armature element, with at least one commutator, with at least one first support element and at least one second support element and with a damping unit according to claim 1, which is arranged on the armature shaft at least partly between the at least one first support element and the at least one armature element and/or at least partly between the at least one commutator and the at least one second support element.

13. A method for producing a damping unit according to claim 1, further comprising at least one method step in which at least one bearing element of the damping unit is at least partly formed in an at least two-step injection molding procedure.

14. The method according to claim 13, comprising at least one further method step, in which the at least one bearing element is treated at least partly by an ultrasonic-welding procedure.

15. The method according to claim 13, comprising at least one further method step, in which at least one hollow space, which is arranged in at least one first injection-molded element or in at least one second injection-molded element of the at least one bearing element, is being at least substantially closed.
